(19) United States
(12) Patent Application Publication
(10) Pub. No.: US 2026/0234474 A1
(43) Pub. Date: Aug. 13, 2026

(54) IMPROVED PROCESS FOR THE PRODUCTION OF BIOCHAR

(71) Applicant: Newlight Technologies, Inc., Huntington Beach, CA (US)

(72) Inventor: Markus Donald HERREMA, Huntington Beach, CA (US)

(73) Assignee: Newlight Technologies, Inc., Huntington Beach, CA (US)

(21) Appl. No.: 19/153,556

(22) PCT Filed: Feb. 8, 2024
(86) PCT No.: PCT/US2024/015028

§ 371 Date: Aug. 4, 2025

Related U.S. Application Data
(60) Provisional application No. 63/444,849, filed on Feb. 10, 2023.

(51) Int. Cl. C10B 53/02; B01J 6/00; C01B 32/05; C10B 47/28; C10B 57/10; C10G 1/02

(52) U.S. Cl. CPC C10B 53/02; B01J 6/008; C01B 32/05; C10B 47/28; C10B 57/10; C10G 1/02; C10G 2300/1014

(57) ABSTRACT

The present specification generally relates to an improved pyrolysis process for the production and processing of biomass into a biochar material. In particular, the disclosure pertains to the use of a continuous external source of gas thereby enhancing safety, increasing process control, providing greater flexibility in the types of feedstocks that can be processed, and an increased yield of the desired products.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present specification generally relates to an improved pyrolysis process for the production and processing of biomass into a biochar material. In particular, the disclosure pertains to the use of a continuous external source of gas thereby enhancing safety, increasing process control, providing greater flexibility in the types of feedstocks that can be processed, and an increased yield of the desired products.

### Description of the State of the Art

Biochar is a form of charcoal that is produced by heating organic matter, such as wood, agricultural residues, or waste materials, in the absence of oxygen. This process, known as pyrolysis, breaks down the organic matter into simpler chemical compounds, such as hydrogen, carbon monoxide, and hydrocarbons, and leaves behind a solid residue known as biochar. The use of biochar as a soil amendment dates back to ancient civilizations, such as the Amazonian civilization in South America, where biochar was used to improve the fertility and productivity of soil. In more recent times, biochar has gained renewed interest as a means of sequestering (storing) carbon dioxide from the atmosphere and mitigating climate change. One ton of biochar sequesters carbon that would have otherwise generated 3.6 tons of carbon dioxide if left to degrade by natural processes. As a form of thermochemical conversion, biochar not only valorizes waste, but it's a very effective method for capturing carbon and storing it in a solid state that can remain stable for centuries.

Biochar has the potential to play a significant role in decarbonizing various materials and sectors. For example, biochar is also being explored as a feedstock for the production of fuels and chemicals, as well as a means of managing waste and improving the environmental sustainability of various industries. Biochar can be used to replace fossil-based carbon black in the production of tires and other rubber products, reducing the carbon footprint of these products by up to 50%. Biochar can also be used to replace fossil-based carbon in the production of plastics and other polymers, reducing the carbon footprint of these products by up to 90%. Biochar can also be used as a substitute for coal in the production of steel and other metals, reducing the carbon footprint of these products by up to 30%. Biochar has a small carbon footprint compared to other forms of carbon sequestration, such as afforestation or reforestation, which require large amounts of land, water, and energy.

There are several methods for producing biochar, including slow pyrolysis, fast pyrolysis, and hydrothermal carbonization. Slow pyrolysis involves heating the feedstocks at a low temperature (300-700° C.) for an extended period of time (several hours to days). Fast pyrolysis involves heating the feedstocks at a higher temperature (500-1,000° C.) for a shorter period of time (seconds to minutes). Hydrothermal carbonization involves heating the feedstocks in the presence of water at high pressure (200-300° C.).

The production of biochar is an exothermic process, that is, it releases heat as a byproduct of the chemical reactions that occur during the process. The heat is generated by the decomposition of the organic matter in the feedstock, which releases gases and liquids that can be used as fuel, and solid residue in the form of biochar. The heat generated during the pyrolysis process is typically used to drive the endothermic reactions that occur during the process, such as the condensation of volatile compounds. However, the temperature needs to be carefully controlled to ensure that the pyrolysis process is efficient and produces the desired products. If the temperature is too low, the process may be incomplete and the yield will be low. If the temperature is too high, the products may be degraded and the yield will also be low. Additionally, certain temperatures, as discussed previously, are required for specific types of pyrolysis, such as fast or slow pyrolysis, to produce the desired products.

Each method has its own advantages and disadvantages, and the most suitable method for a given application will depend on the feedstocks, the desired products, and the available resources. Slow pyrolysis tends to produce a higher yield of biochar, but also generates more by-products such as syngas (a mixture of hydrogen and carbon monoxide). Fast pyrolysis tends to produce a higher yield of liquid and gaseous products, such as bio-oil and biogas, but also generates more tars and contaminants. Hydrothermal carbonization tends to produce a higher yield of biochar, but also generates more water and requires specialized equipment.

Overall, the pyrolysis process has the potential to provide a sustainable and cost-effective means of producing biochar and other valuable products from a wide range of feedstocks. However, the process still faces challenges such as low yields, high costs, and environmental impacts, which need to be addressed in order to achieve widespread adoption.

Thus, a need exists for providing a pyrolysis process that demonstrates enhanced safety, more precise control over the pyrolysis process, allowing for more consistent production of the desired products, greater flexibility in the types of feedstocks that can be processed, and increased yields of the desired products.

### BRIEF SUMMARY

Accordingly, the object of the present disclosure can be defined by the use of a continuous stream of an external gas that supplements the heat generated by the exothermic reaction of the pyrolysis process itself to form a various pyrolysis products. In other words, by supplementing the heat by using an outside source of gas, the pyrolysis process of the present disclosure would demonstrate enhanced safety, more precise control over the pyrolysis process, allowing for more consistent production of the desired products, greater flexibility in the types of feedstocks that can be processed, and increased yields of the desired pyrolysis products. The pyrolysis products can be divided into a solids component or fraction, such as biochar and a vapor (condensable) and gas (non-condensable) component or fraction.

It is a still further object of the present disclosure to provide a safer pyrolysis process for the production and processing of biomass using a continuous external source of gas thereby reducing the risk of fires or explosions that can occur when the feedstock is burned.

It is a still further object of the present disclosure to provide more precise control over the pyrolysis process by using a continuous external source of gas thereby allowing for a more precise control of temperatures thereby providing a more consistent production of the desired pyrolysis products.

The present disclosure further provides greater flexibility in the types of feedstocks that can be processed as the temperature and heating rate of the drying process as well as the pyrolysis process can be controlled more precisely when using an external source of gas.

In addition, it is a particular object of the disclosure to increase pyrolysis product yields as a result of more consistent heating.

Additional embodiments and features are set forth in the description that follows, and in part will become apparent to those skilled in the art upon examination of the specification or may be learned by the practice of the disclosed embodiments. The features and advantages of the disclosed embodiments may be realized and attained by means of the instrumentalities, combinations, and methods described in the specification.

### BRIEF DESCRIPTION OF THE DRAWINGS

A further understanding of the nature and advantages of the disclosed embodiments may be realized by reference to the remaining portions of the specification and the drawings. All drawings are not to scale.

FIG. 1 is a is a schematic diagram of a non-limiting example system useful for the pyrolysis process of the present disclosure.

While the disclosure is amenable to various modifications, specifics thereof have been shown by way of in the drawings and will be described in detail in the following more detailed description. It should be understood, however, that the intention is not to limit the disclosure to the particular embodiments described. On the contrary, the intention is to cover all modifications, equivalents, and alternatives falling within the spirit and scope of the disclosure as defined by the appended claims.

In the appended figures, similar components and/or features may have the same reference label. Further, various components of the same type may be distinguished by following the reference label by a dash and a second label that distinguishes among the similar components. If only the first reference label is listed in the specification, the description is applicable to anyone of the similar components having the same first reference label irrespective of the second reference label.

### DETAILED DESCRIPTION

Although certain preferred embodiments and examples are disclosed below, the inventive subject matter extends beyond the specifically disclosed embodiments to other alternative embodiments and/or uses and to modifications and equivalents thereof. Thus, the scope of the presently disclosed is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present technology.

In general, production of pyrolysis products such as, biochar, bio-gas, and bio-oil is an exothermic process, that is, large organic molecules are broken down into smaller ones through heating in the absence of oxygen. This process releases heat energy which can be used to dry the biomass as well as drive the pyrolysis reaction which is often referred to as “closed-loop” or “recirculating” pyrolysis and combustion. The present disclosure, however, describes a process which not only utilizes the heat produced from the pyrolysis process but further relies upon the consistent use of an external gas supply. Using an external source of gas for heating in the pyrolysis process will allow for greater flexibility in the types of feedstocks that can be processed because it provides more consistent and controlled heating conditions. With an external source of gas, the temperature and heating rate can be controlled more precisely, which can help to ensure that the feedstock is decomposed in a consistent manner. This is particularly important for feedstocks that have varying compositions or moisture levels, as these can impact the quality and yield of the biochar produced. By using an external source of gas, the heating of the feedstock is no longer dependent on the feedstock itself, which can reduce the risk of combustion and improve the safety of the process. Overall, using an external source of gas can help to improve the efficiency and consistency of the pyrolysis process, enhanced safety, and increase yields of the desired products.

The disclosed subject matter is beneficial in that a wide variety of starting materials may be used as the feedstock in the pyrolysis process. Particularly, any type of biomass may be used. In specific embodiments, the biomass starting material used in the pyrolysis process of the present disclosure can comprise a wide variety of nonhazardous, organic materials. For example, biomass may include, but is not limited to, any of the following (1) forest-related resources: mill residues, precommercial thinnings, slash, and brush, or nonmerchantable material; (2) solid wood waste materials, including waste pallets, crates, dunnage, manufacturing and construction wood wastes (other than pressure-treated, chemically-treated, or painted wood wastes), and landscape or right-of-way tree trimmings, or paper that is commonly recycled; (3) agriculture wastes, including orchard tree crops, coconut husks, coconut shells, corn cobs, cornhusks, vineyard, grain, legumes, sugar, and other crop by-products or residues, containing a high amount of lignocellulosic material; or (4) plants grown exclusively as a fuel for the production of electricity. Exemplary plants useful as a fuel for energy production include switchgrass, miscant-hus, energy canes, sorghum, willows, poplar, and eucalyptus.

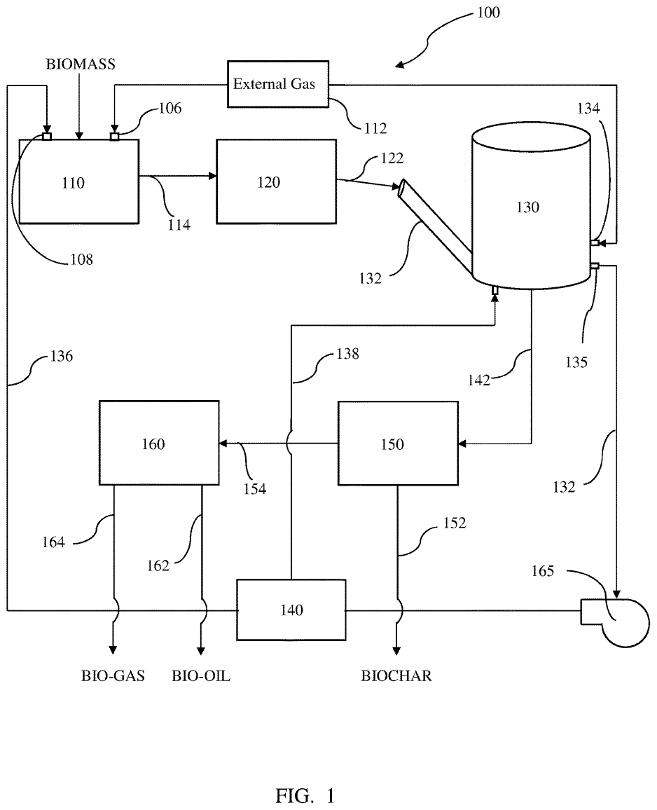

FIG. 1 shows a block flow diagram of a biomass pyrolysis process 100 according to one embodiment of the present disclosure. As shown therein, a biomass is first prepared by a drying step followed by a size reduction step or particularization. The biomass is fed into drier 110 until the moisture content of the biomass preferably is as close as possible to 0% by weight. Moisture content of the biomass can be adjusted external to the process or internally by integrating a heat source to maintain the input biomass to a moisture content of about 15% or less, about 10%, about 7%, or about 5% or less by weight. The typical drying temperature used to dry biomass before pyrolysis can vary depending on the type of biomass and the drying method used. However, the temperature should not exceed the ignition temperature of the biomass, as this can result in combustion rather than drying. Drier 110 comprises a chamber for receiving the biomass through an inlet, pilot burners (not shown) fueled by external gas 112 entering inlet 106 to heat and dry the biomass, an additional inlet 108 which receives heat 136 produced from the pyrolysis reaction, and an outlet for removal of the dried biomass. The dried biomass can then be delivered as a stream 114 to grinder 120 where it is converted to a particularized form. The particle size may be controlled through a combination of grinding, shredding, or milling processes before the biomass is fed into pyrolysis reactor 130. The specific particle size requirements for a given pyrolysis process will depend on the type of reactor being used, the type of biomass, and the desired product outputs. Following the grinding step the particularized biomass exists grinder 120 as stream 122 and is delivered to a pyrolysis reactor 130. Ideally, the size of the dried biomass 122 prior to introduction into pyrolysis reactor 130, can be such that heat transfer rates are high enough to maximize bio-oil production. Cost of size reduction and bio-oil yield preferably are balanced. In certain embodiments of the present process, biomass particles can have an average size of about 25 mm or less, about 20 mm or less, about 10 mm or less, about 5 mm or less, about 2 mm or less, or about 1 mm or less. In specific embodiments, average particle size can be about 0.1 mm to about 25 mm, about 0.1 mm to about 20 mm, about 0.1 mm to about 10 mm, about 0.1 mm to about 5 mm, or about 0.1 mm to about 2 mm. It is important to note that the particle size of the biomass has a significant impact on the efficiency and rate of the pyrolysis reaction. Smaller particle sizes increase the surface area-to-volume ratio, allowing for more efficient heat transfer and faster reaction times. Larger particle sizes can result in longer reaction times and lower overall yields.

Pyrolysis reactor 130 generally comprises (i) a heating chamber (not shown) which is the main component of the reactor where the pyrolysis process takes place. It is designed to maintain a controlled temperature and heating rate to optimize the reaction conditions; (ii) a feeding system 132 is used to introduce the biomass into the heating chamber. It may include a feeder, a conveyor belt, or a screw feeder; and (iii) a temperature control system necessary to maintain a constant temperature within the heating chamber during the reaction. In some embodiments, pyrolysis temperatures can be in the range of about 200° C. to about 900° C., about 200° C. to about 700° C., about 200° C. to about 600° C., about 200° C. to about 550° C., about 250° C. to about 500° C., or about 300° C. to about 500° C. In specific embodiments, lower temperature ranges may be beneficial for minimizing undesirable thermal effects, such as cracking, and the use of specific catalysts may be beneficial in such embodiments. For example, reacting of the biomass in the presence of the catalyst can be carried out at a temperature of about 600° C. or less, about 550° C. or less, or about 500° C. or less. Residence time in the reactor can be as noted above and, specifically, can be about 0.5 seconds to about 5 seconds, about 0.5 seconds to about 4 seconds, about 0.5 seconds to about 3 seconds, or about 0.5 seconds to about 2 seconds. The present disclosure makes use of both hot gas circulation referred to as “closed-loop” or “recirculating” pyrolysis and combustion as discussed previously. Hot gas 132, exiting pyrolysis reactor 130 via outlet 135 is directed through pump 165 and heat exchanger 140. Heat exchanger 140 further controls the temperature of gas 132 and releases stream 136 and 138. Stream 136 is directed to drier 110, via inlet 108 to transfer heat to the incoming biomass. This pre-heats the biomass, reducing the energy required for the reaction and increasing its efficiency. Stream 138, can be scrubbed, to remove impurities (scrubber not shown) and recirculated back into pyrolysis reactor 130 to provide additional heat. By using the gases 136 and 138 produced during the pyrolysis reaction to drive the reaction and dry the biomass, closed-loop pyrolysis can increase the energy efficiency of the process and reduce the need for external heating sources. However, it also requires careful control of the reaction conditions and the composition of the recirculating gases to ensure safe and consistent operation of the reactor. The present disclosure however, further makes use of combustion, wherein both drier 110 and reactor 130 comprise burners in a separate combustion chamber which is heated through the combustion of external fuel 112, such as natural gas. The hot gases generated by the combustion are then used to heat the heating chambers, thereby giving much more precise control over the temperatures at which the reactions are taking place. External gas 112 can be sourced from a variety of methane-based gas sources, such as but not limited to, conventional natural gas, that is the most common form of natural gas found in underground reservoirs; unconventional natural gas, that is the type of natural gas found in tight rock formations, such as shale, and is typically flared; coalbed methane, that is found in coal seams and is extracted along with coal; biogas, that is, a form of renewable natural gas that is produced through the anaerobic digestion of organic matter, such as livestock manure or food waste; and synthetic natural gas (SNG), that is, a form of natural gas that is produced from coal, biomass, or waste through the process of gasification. The choice of source will depend on factors such as cost, availability, and environmental impact. Certainly, the use of flared gas or gas that would otherwise be vented or released to the atmosphere would be the preferable option if available, as this would have the greatest positive environmental impact and have a positive impact on the carbon footprint of the pyrolysis products, including resulting in biochar with a reduced carbon footprint, neutral carbon footprint, or more negative carbon footprint.

Pyrolysis products, as stream 142 can be separated using a combination of physical and chemical processes. The specific methods will be apparent to those skilled in the art and will depend on the type of pyrolysis process and the desired product outputs. For example, solid and liquid products can be separated from the gases using filters or other physical separation methods, such as centrifugation or sedimentation; liquid or solid products can also be extracted from the mixture using solvents or other chemical extraction methods. The present disclosure makes use of cyclone 150 which is a simple and effective method of separating solid particles from gas stream 142, and can be used in a variety of pyrolysis processes to improve the efficiency and quality of the product outputs. Cyclones are mechanical separation devices that use centrifugal force to separate particles from a gas stream based on their size and density. In pyrolysis, the hot gases and solids produced during the reaction are passed through cyclone 150, where the solids, that is, the biochar can be separated from the gases, as stream 152, and collected. Biochar is a stable, carbon-rich material that can be used as a soil amendment to improve soil fertility and structure. Alternatively, biochar can be used as a substitute for fossil-based materials, such as petroleum-based plastics, and it is possible to reduce the carbon footprint of the material and potentially offset the emissions associated with its production and use. Consequently, the present disclosure discloses a path to produce pyrolysis products that are both renewable and sustainable having low carbon negative values that when used in combination with other fossil-based materials can result in decreasing the carbon footprint of the entire final product to neutral or negative.

The remaining gas stream 154 exiting cyclone 150 is then directed to a condensation system or condenser unit 160 where stream 154 is typically cooled to condense the vapor into a liquid form that typically contains an aqueous phase and an organic phase. The aqueous phase can be predominately water (e.g., about 40% to about 99% water) with water soluble organic materials such as acids (e.g., acetic acid), phenols, and unconverted anhydro-sugars. The organic phase typically has a much lower oxygen content than the water-rich aqueous phase and different physical properties such as density, polarity, and/or other properties. The two phases are physically separated and the hydrocarbon-rich bio-oil stream 162 is collected. The bio-oil produced by pyrolysis can be further refined to produce a range of chemical products such as fuels, solvents, and lubricants.

Also exiting condenser unit 160 will be stream 164, comprising a mixture of water vapor, light gases such as hydrogen and carbon monoxide, and potentially volatile organic compounds (VOCs). The exact composition of these bio-gases can vary depending on the feedstock used and the conditions of the pyrolysis process. Stream 164 can be further purified as desired.

Primary benefits of using external gas 112 is the efficient drying of biomass and controlling the temperature of the pyrolysis process more accurately, which can lead to a more consistent and efficient production of the desired products. Additionally, using external source of gas 112 can help to reduce the emissions and pollutants that are produced during the pyrolysis process, as well as increase the energy efficiency of the process. This is because the external source of gas 112 can be used to provide heat to the system, rather than relying on the burning of the feedstock itself.

### Additional Embodiments

In the foregoing specification, the disclosure has been described with reference to specific embodiments thereof. It will, however, be evident that various modifications and changes may be made thereto without departing from the broader spirit and scope of the disclosure. The specification and drawings are, accordingly, to be regarded in an illustrative rather than restrictive sense.

Indeed, although this disclosure has been discussed in the context of certain embodiments and examples, it will be understood by those skilled in the art that the disclosure extends beyond the specifically disclosed embodiments to other alternative embodiments and/or uses of the disclosure and obvious modifications and equivalents thereof. In addition, while several variations of the embodiments of the disclosure have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the embodiments of the present disclosure. Any methods disclosed herein need not be performed in the order recited. Thus, it is intended that the scope of the present disclosure should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the disclosure is not to be limited to the particular forms or methods disclosed, but, to the contrary, the disclosure is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein. Overall, the language of the claims is to be interpreted broadly based on the language employed in the claims. The claims are not to be limited to the non-exclusive embodiments and examples that are illustrated and described in this disclosure, or that are discussed during the prosecution of the application.

Those skilled in the art will also appreciate that in some embodiments the functionality provided by the components, structures, methods and processes discussed above may be provided in alternative ways, such as being split among more components or methods or consolidated into fewer components or methods. In addition, while various methods may be illustrated as being performed in a particular order, those skilled in the art will appreciate that in other embodiments the methods may be performed in other orders and in other manners.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of a renewable and sustainable process for the production of pyrolysis products have been disclosed. Although the systems, techniques, and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

1. A renewable and sustainable process for the production of biochar from a pyrolysis reaction, the process comprising:
(a) providing a pyrolysis reactor vessel equipped with heating elements and at least two gas inlets;
(b) feeding a continuous stream of gas, not derived from the pyrolysis reaction, into said pyrolysis reactor vessel through at least one of said at least two gas inlets;
(c) heating said gas to a temperature sufficient to cause pyrolysis, or the breakdown of said gas into solid and gaseous pyrolysis products;
(d) separating said solid and gaseous pyrolysis products from one another;
(e) collecting said solid and gaseous pyrolysis products; and
(f) purifying said solid and gaseous pyrolysis products as needed for use in various applications.

2. The process of claim 1, further comprising providing a drier having at least two gas inlets.

3. The process of claim 1, further comprising feeding a continuous stream of external gas, not derived from the pyrolysis reaction, into said drier through at least one of said at least two gas inlets.

4. The process of claim 1, wherein said pyrolysis products comprise said biochar stream, and said bio-oil stream.

5. The process of claim 2, further comprising the production of a heated gas product from the pyrolysis reaction.

6. The process of claim 5, wherein said heated gas product from the pyrolysis reaction is directed to said heater.

7. The process of claim 2, wherein said heated gas product from the pyrolysis reaction is directed to said pyrolysis reactor.

8. The process of claim 1, further comprising the production of a heated gas product from the pyrolysis reaction.

9. The process of claim 8, wherein said heated gas product from the pyrolysis reaction is directed to said pyrolysis reactor.

10. The process of claim 3, wherein said external gas is a methane-based gas.

11. The process of claim 10, wherein said methane-based gas is sourced from fracking operations, or coal mines.

12. The process of claim 10, wherein the methane-based gas comprises natural gas.
